(19) United States
(12) Patent Application Publication
(10) Pub. No.: US 2011/0106792 A1
(43) Pub. Date: May 5, 2011

(54) System and method for word matching and indexing

(75) Inventor: Ian Robertson, Cambridge (GB)

(73) Assignee: I2 LIMITED, Fulbourn (GB)

(21) Appl. No.: 12/940,057

(22) Filed: Nov. 5, 2010

Related U.S. Application Data
(60) Provisional application No. 61/258,299, filed on Nov. 5, 2009.

(51) Int. Cl. G06F 17/30; G10L 15/04

(52) U.S. Cl. 707/723; 704/254; 707/769; 707/741; 704/E15.001; 707/E17.014; 707/E17.002

(57) ABSTRACT

The invention provides a method for retrieving similar sounding words from an electronic database. An input or query word is first converted to a string of corresponding phonemes. The string of phonemes is then used to generate a key, with the key made up of elements corresponding to the phonemes. In a preferred embodiment the key elements correspond to classes of phonemes. The electronic database comprises a plurality of words, each of which have a corresponding, phoneme-based key. Words in the database having a key identical to the key of the input word are retrieved and output. The use of phonemes in generating the search key results in the retrieval of similar sounding words. In another aspect, the invention provides a method of providing a similarity score for an output word or a list of output words compared to an input word. All of the output words are converted into phonemes and the score is based on a comparison of the phonemes in the input word with the phonemes in each output word.

### CROSS-REFERENCE TO RELATED APPLICATIONS

This application claims the benefit of application No. 61/258,299 filed Nov. 5, 2009, which application is incorporated herein by reference for all purposes.

### FIELD OF THE INVENTION

The present invention relates to a method, system and computer program product for indexing a database of words using phoneme-based keys and for retrieving words from a database that are similar to an input word using the phoneme-based keys. The invention also provides a system and method for ranking or scoring the degree of similarity between two words based on a comparison of phonemes.

### BACKGROUND TO THE INVENTION

There are many situations in which databases are searched for records matching a particular input word. When using textual input, often the input word or words can have more than one valid spelling. For example, translations of names from one alphabet or writing system to another can often lead to more than one valid spelling. An input word can also simply be misspelled or misheard and then incorrectly transcribed. In either of these circumstances it is desirable to be able to retrieve not just records exactly matching the input text but also similar records.

If an input word is provided to a search engine via a speech recognition system, the input word may be inaccurately converted to text or there may be more than one valid spelling for the input word. In this circumstance it is also desirable to be able to retrieve similar words to the input words, not just exact matches.

One application in which retrieval of similar words is particularly desirable is in searching for people's names. Law enforcement agencies often need to search for names, sometimes names of foreign nationals whose names may have plural valid spellings. For example, Saddam Hussein has at least three accepted spellings in major American newspapers.

There are several systems currently available that address this problem, using phonetic indexing algorithms. Some use the Soundex™ algorithm. However, Soundex™ typically produces too many false positives, to the extent that users have to spend far too long analysing the results. Other systems use the Metaphone™ or Double Metaphone™ algorithm. Metaphone™ is an improvement on the Soundex™ algorithm but Metaphone™ and Double Metaphone™ systems still miss similar sounding words and also retrieve too many poor matches.

Accordingly, there exists the need for an improved method and system for retrieving similar words from a database, and in particular a system that improves on the Soundex™ and Metaphone™-based systems.

### SUMMARY OF THE INVENTION

The present invention is defined in the appended claims to which reference should now be made.

In one aspect, the invention is a method for retrieving similar sounding words from an electronic database. An input or query word is first converted to a string of corresponding phonemes. The string of phonemes is then used to generate a key, with the key made up of elements corresponding to the phonemes. In a preferred embodiment the key elements correspond to classes of phonemes. The electronic database comprises a plurality of words, each of which have a corresponding, phoneme-based key, preferably held in an index. Words in the database having a key identical to the key of the input word are retrieved and output. The use of phonemes in generating the search key results in the retrieval of similar sounding words.

In another aspect, the invention provides a method of providing a similarity score for an output word or a list of output words compared to an input word. All of the output words are converted into phonemes and the score is based on a comparison of the phonemes in the input word with the phonemes in each output word. Preferably, a difference score indicative of the similarity between two phonemes is assigned to each possible pair of phonemes. The similarity score for an output word is calculated using a distance function, and preferably an edit-distance function, based on the difference scores. The scores can be normalised to account for different length words.

The difference scores may in fact be indicative of the dissimilarity between phonemes, and the terms “similarity score” and “measure of similarity” as used herein should be understood to include a measure of dissimilarity.

### BRIEF DESCRIPTION OF THE DRAWINGS

Examples of the present invention will now be described with reference to the accompanying drawings in which:

FIG. 1 is an illustration of the phoneme set of the Microsoft Speech API as defined for general American English;

FIG. 2 illustrates a system for generating phoneme strings from input words, for use in the present invention;

FIG. 3a shows the set of phoneme manner of articulation classes and the symbol used for each class;

FIG. 3b illustrates a system for generating keys from phoneme strings in accordance with the invention;

FIG. 4 is a schematic illustration of a system in accordance with the present invention;

FIG. 5 is a schematic illustration of a method in accordance with the present invention;

FIG. 6a illustrates an example of a first phoneme-phoneme distance score table;

FIG. 6b illustrates an example of a second phoneme-phoneme distance score table;

FIG. 7 illustrates a word difference calculation, when comparing two words; and

FIG. 8 illustrates a set of output words generated by Double Metaphone™ and a corresponding set of scores produced by a scoring system in accordance with the present invention.

### DETAILED DESCRIPTION

Definitions

As used herein the term “word” means any pronounceable unit of language including names of people and names of places. A “word” can be in any language and can take any written form e.g. it can be expressed in any alphabet or writing system.

As used herein the term “database” includes any structured collection of data stored on a physical medium in some way. A database may be distributed across a network or may completely reside in a single location.

Phonemes and the Phonetic Alphabet

Phonemes are symbols representing specific sounds used in spoken language.

Metaphone™ is a phonetic algorithm but it does not use phonemes. Instead, Metaphone™ uses its own specific code to encode 16 consonant sounds into Metaphone™ keys. All vowels are stripped out of words before encoding into keys.

In contrast, the present invention is based on the use of phonemes. The present invention first converts words into corresponding phoneme strings and then encodes the phoneme strings into keys. The keys are then used as the basis for retrieving words from a database. The use of keys based on phonemes results in better and more accurate retrieval. In the embodiments described, only words having a key matching the key of an input word are retrieved. However, other schemes are possible, such as retrieving words having a key with a predetermined minimum number of elements in common.

The standard phonetic alphabet of the International Phonetic Association (IPA) contains around 100 phonemes, many of which are sounds not used in English or in other Indo-European languages. A system in accordance with the present invention may use all 100 phonemes or, more preferably, a sub-set of those phonemes specific to the language, or languages, being used to provide the results.

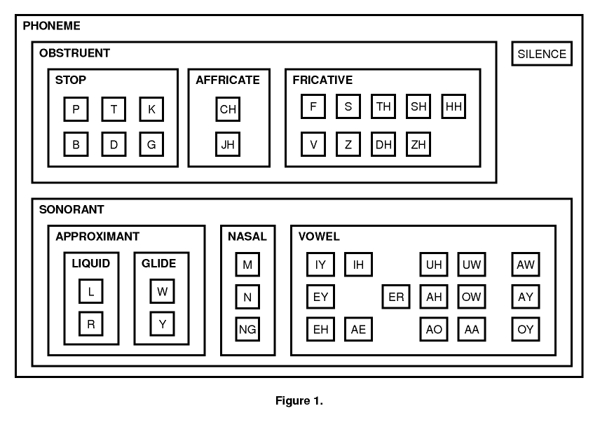

In the embodiment of the invention described below, the symbols of the Microsoft Speech API (MS-SAPI) as defined for general American, the accent of American English perceived by Americans to be the most “neutral” and free of regional characteristics, are used. A hierarchical classification of this phoneme set is illustrated in FIG. 1.

The phoneme set shown in FIG. 1 is partitioned into 24 consonants, 15 vowels and a silence phoneme. The phonemes are divided into manner of articulation classes. These classes are: stop, affricate, fricative, approximant, nasal and vowel (and silence). However, the phoneme set can also be classified in other ways, such as place of articulation, voicing and sonority.

Phonetic Transcription

As already described, a system in accordance with the present invention requires all input words to be transcribed into phonemes in order to then generate a key.

Several algorithms are known for the automatic translation of words or strings of words into sounds i.e. phonemes. These algorithms were originally designed for use in text-to-speech (TTS) applications, where the aim is the automatic articulation of a piece of written text. However, the technology is just as applicable in the present invention.

In a preferred embodiment, an approach developed by Kevin Lenzo and Vincent Pagel at Carnegie Melon University (CMU) department of linguistics is used, which uses a phonetic dictionary for direct look-up of phonetic transcriptions whenever possible, but falls back on a set of transcription rules to handle out of dictionary cases.

The CMU pronouncing dictionary is publicly available and downloadable from the Internet and is a machine readable pronunciation dictionary for North American English that contains 125,000 words and names together with their phonetic transcriptions in the phoneme set shown in FIG. 1.

For words that are not in this dictionary, phonetic transcription is handled by using the large number of transcriptions provided within the dictionary to train a decision tree that is capable of making an accurate determination of the likely pronunciation of any unincluded words. The process for training a decision tree in this manner is described in detail in Pagel V., Lenzo K., and Black A. W. (1998) “Letter to sound rules for accented lexicon compression.” Proc. ICSLP, Sydney, Australia, the contents of which are incorporated herein by reference. The CMU pronouncing dictionary comes with a number of Perl scripts which can be used for constructing text-to-phoneme (TTP) decision trees using the Iterative Dichotomiser 3 (ID3) tree learning algorithm. These scripts are also publicly available and are free to use.

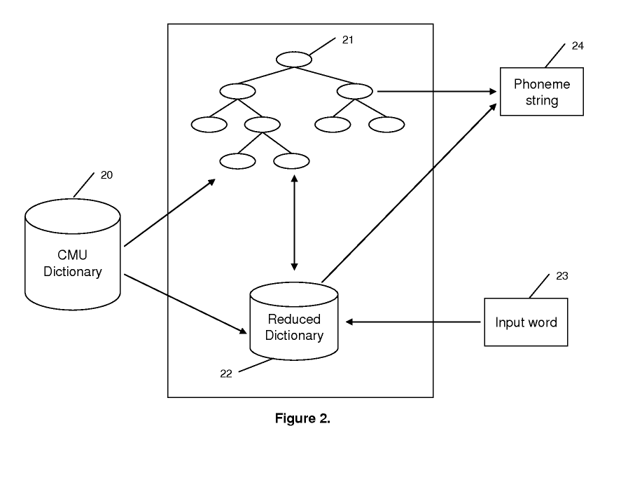

In a preferred embodiment, once the decision tree has been constructed, each word from the original phonetic dictionary is run through the decision tree and compared with the predicted pronunciation within the dictionary. Any words that are correctly predicted by the tree can be eliminated from the dictionary, resulting in a smaller dictionary containing only those words transcribed incorrectly. The smaller, reduced dictionary has a correspondingly smaller memory requirement. This is illustrated in FIG. 2.

FIG. 2 illustrates the CMU Dictionary 20, which is used to train the transcription decision tree 21. Once the decision tree is finalised, the words in the CMU Dictionary are passed through the decision tree. Those words which the decision tree correctly transcribes are eliminated from the reduced dictionary. Only those words in the CMU that are not correctly transcribed are retained to form the reduced dictionary 22. In use for transcription, a word 23 is input and the reduced dictionary 22 is first checked. If the input word is in the reduced dictionary, the corresponding phoneme string 24 is output. If the input word is not in the reduced dictionary, the decision tree 21 is then used to transcribe the input word into a string of phonemes 24.

The original CMU pronouncing dictionary is 3,507 kb in size, whereas the corresponding decision tree and reduced dictionary occupy just 723 kb and 546 kb respectively. Eliminating words from the dictionary that are correctly transcribed by the decision tree therefore saves considerable memory resources.

However, as an alternative, phonetic transcription can be carried out simply by using a phonetic dictionary such as the CMU dictionary.

As a further alternative, phonetic transcription can be carried out solely using a decision tree, without reference to any form of dictionary.

The choice of dictionary employed for lookup or decision tree training is typically determined by the language being used. Many machine-readable phonetic dictionaries are freely available for download on the internet. Alternatives include BOMP (German), Lexique (French) and the MBRDICO project which provides dictionary resources for several languages. The Unicode Unihan database provides detailed properties and pronunciations for the characters used in Chinese, Japanese and Korean orthography.

Phonetic Keys

In order to support phonetic indexing and retrieval of words and names from a database, the present invention incorporates a system for the generation of phonetic index keys. These keys are based on the phoneme transcriptions described above with reference to FIG. 2.

In this example, phonetic keys are generated by mapping each phoneme in a phoneme string corresponding to a word to its corresponding phonetic manner of articulation class. The phonetic manner of articulation classes are illustrated in FIG. 1.

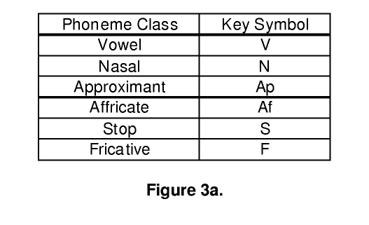

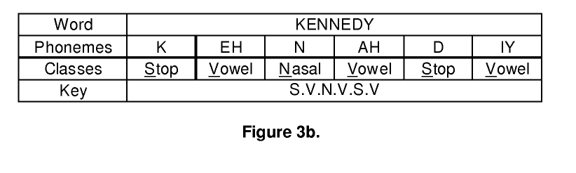

FIG. 3a shows the set of phoneme manner of articulation classes and the symbol used for each class herein.

FIG. 3b illustrates the generation of a phonetic key for the word “Kennedy” illustrating the conversion of “Kennedy” first to its string of phonemes and then to a phonetic key.

“Kennedy” is first transcribed to a phoneme string K EH N AH D IY. This phoneme string is used to generate a key S.V.N.V.S.V. (representing stop, vowel, nasal, vowel, stop, vowel—the manner of articulation classes for each of the phonemes in the phoneme string). Other ways of generating a key could be used, based on different classifications of the phoneme set being used. Importantly, each element of the key is not necessarily unique to a particular phoneme, so that similar sounding words may share the same key. Another way of expressing this is that the set of possible elements forming the keys (in the illustrated case the manner of articulation classes) has fewer members than the set of possible phonemes.

It is also possible to map pairs or strings of adjacent phonemes in a phoneme string to a single key element, rather than transforming each individual phoneme to a key element.

Database Indexing and Word Retrieval

In this invention, keys based on phoneme strings are used for indexing a database or dictionary of records and for retrieving records from the database.

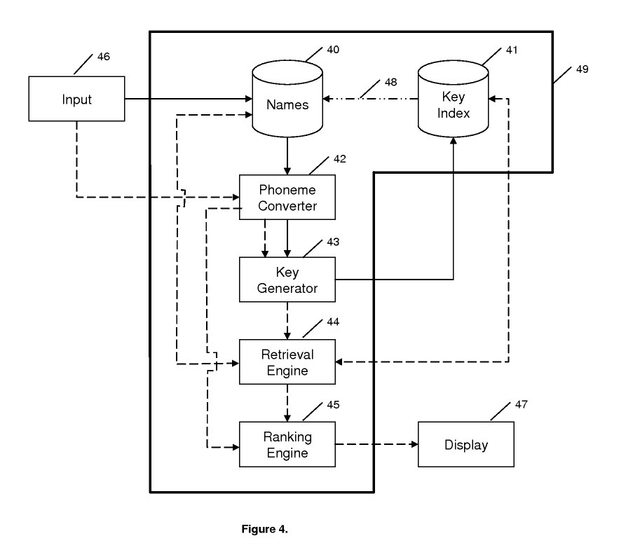

FIG. 4 illustrates a system for indexing a database of names and subsequently for retrieving similar sounding names to an input name from a database, in accordance with the invention. The system includes a database of names 40 and a corresponding key index 41. The key index 41 comprises keys corresponding to each of the names in the database 40. The keys are generated from the names as described with reference to FIG. 3. The key index 41 can form part of database 40, or can be separate from it, instead including pointers to the relevant entries in the name database 40. Accordingly, the key index 41 can be stored on the same or separate hardware to the name database. The name database may be stored on a single piece of hardware or may be distributed across a network. The name database may also include additional, related information to the names.

The system also includes a phoneme converter 42, a key generator 43 and a retrieval engine 44. These elements are implemented as software modules running on one or more computer processors that are coupled to the name database 40 and key index 41. A ranking engine 45 is also included. The ranking engine is typically implemented as software as well and will be described in more detail below.

The phoneme converter may simply be a dictionary or look-up table stored in a memory or may include a decision tree or other algorithm as described with reference to FIG. 2. The key generator generates keys from the output of the phoneme converter in the manner described with reference to FIG. 3. The retrieval engine compares an input key with keys stored in the key index 41 and retrieves words from the database 40 having a corresponding key matching the input key. This type of searching routine is well known in the art. The phoneme converter, key generator and retrieval engine can be provided as software and data on a computer program product such as an optical disc, which stores program code which can run on a PC or other computing device. Similarly, the ranking engine can be provided on a computer readable storage medium, and can be provided as part of the phoneme converter, key generator retrieval engine product or as a separate product, including a phoneme converter module.

The database 40, key index 41, phoneme converter, 42, key generator 43, retrieval engine 44 and ranking engine 45 are all illustrated in FIG. 4 as residing on a single computing device 49, which would typically be a PC or laptop. However, each of these elements may be stored and executed or remote (but connected) devices. The database and key index may be distributed over several devices and connected over a network.

In a setting up phase, the system can be used to generate the entries in the key index 41. The steps in this initial phase are illustrated by the arrows shown in solid line.

The name database receives a name from a user input 46, such as a keyboard or a microphone. Any suitable user input may be used for inputting a name into the system. The name is stored in the database and is passed to the phoneme converter 42, which converts the name into a string of phonemes, as described with reference to FIG. 2. The string of phonemes may consist of a single phoneme or a plurality of phonemes. The string of phonemes is passed to the key generator 43 where it is converted into a key, as described with reference to FIG. 3. The key is then passed to the key index, where it is stored together with a pointer (illustrated by the dash/dot line 48) to the corresponding entry in the names database 40. In this manner, a database of names and a corresponding index of keys can be generated.

In a subsequent phase of use, the system is used to retrieve names from the database having a similar pronounced sound to an input name. The steps of this phase of use are illustrated by the arrows in dotted line. An input name is input to the system via input 46, which, as described, may be any suitable input means such as a keyboard, mouse, touch screen, microphone, etc. The input name is received by the phoneme converter where it is converted into a corresponding string of phonemes as described with reference to FIG. 2. The string of phonemes is passed to the key generator where it is converted into a key as described with reference to FIG. 3, and the key is then passed to the retrieval engine 44. The retrieval engine searches the key index 41 for records having a key matching the key generated from the input name (hereinafter referred to as the input key). If there are records having a matching key, those records are retrieved from the names database and passed to an output display 47, to be viewed by a user. In this embodiment, only names having an identical key to the input name are retrieved and displayed to the user. In alternative embodiments, records having similar keys, e.g. having only one symbol different, are also be displayed or otherwise communicated to the user.

It is possible that an input word may have more than one valid phonetic transcription in the dictionary. This might be the result of different regional/national pronunciations. In that case, a plurality of different keys are generated for the input word and matching records for all the different keys are retrieved.

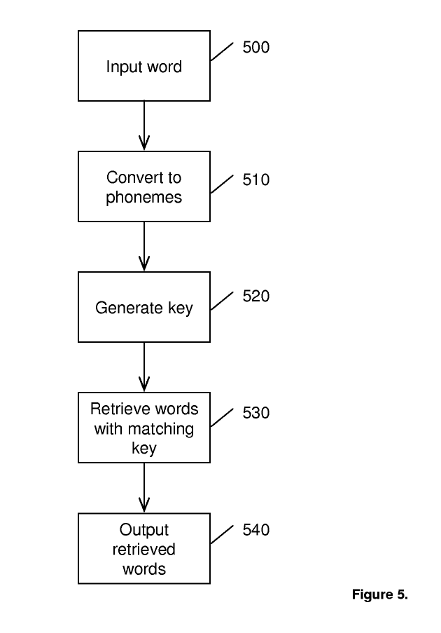

FIG. 5 is a flow diagram illustrating the method steps carried out in retrieving similar words from a database of words in accordance with the present invention. The database and retrieval system are implemented electronically using computer hardware including one or more computer processors, as described with reference to FIG. 4. In a first step 500, an input word is input to the computer hardware via a suitable user input device, such as a keyboard. The input word is converted to a string of phonemes at step 510 and the string of phonemes used to generate an input key at step 520. The input key is then used to retrieve words with matching keys from a database. The input key is compared with keys in a key index or database and those words having identical keys to the input key are retrieved from the database in step 530. The retrieved words are similar in pronounced sound to the input word. The retrieved words are output to the user in some way in step 540, typically by displaying them on a screen.

Ranking Engine

A ranking engine 45 is also included in the system of FIG. 4, between the retrieval engine and the display. The ranking engine is preferably implemented in software (although it may be implemented in hardware or a combination of software and hardware) and is used to provide a similarity score for the retrieved names or to sort the names in order of similarity.

In order to provide a measure of the similarity between two words, some kind of similarity metric must be used. In accordance with the present invention the similarity metric is based on a comparison between pairs of phonemes in the phoneme strings. A distance function is used to provide an overall similarity score for a pair of words. A distance function is a function which accepts a pair of words as input and returns a non-negative numerical value. The returned value is zero if the two words sound identical and increases with increasing dissimilarity in the sound of the two words. An edit-distance function is preferably used to allow different length phoneme strings to be compared.

There is a large body of research supporting the belief that phonemes sharing similar distinctive features, particularly the manner of articulation, are more likely to be confused with each other than phonemes with dissimilar distinctive features. Hence it is expected that the voiced velar plosive G is more easily confused with the voiceless velar plosive K than with the unvoiced alveolar fricative S. Accordingly, the surname pair Geller-Keller should be scored as more similar than a surname pair Geller-Seller. Similarly, front-mid vowels EY and EH (as in eight and pet) are more easily confused with each other than with the back close vowel UW (as in too).

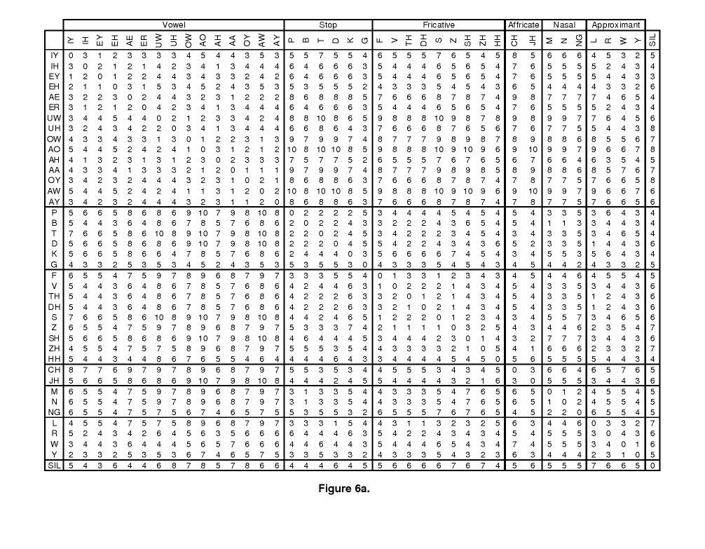

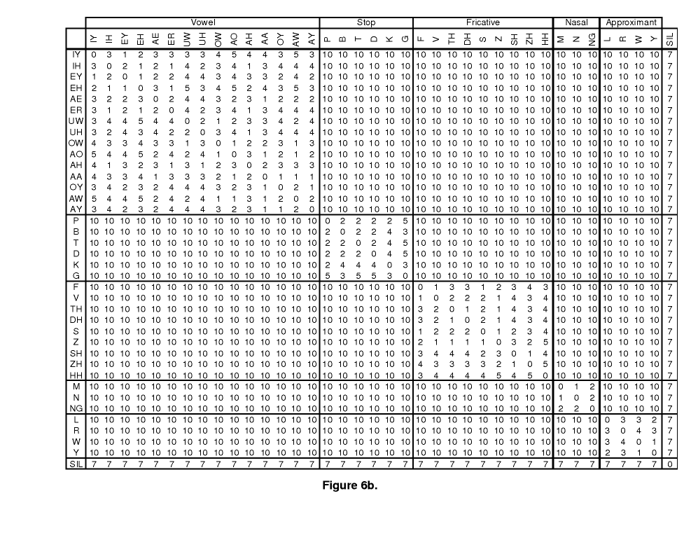

Accordingly, in a preferred embodiment of the present invention, a set of distinctive phonological features is used as the basis for the similarity metric. In a preferred embodiment the phonological feature system that is used is based on the Sound Pattern of English (SPE) feature system—see “The Sound Pattern of English” (Chomsky, N. and Halle, M 1968) M.I.T. Press, Cambridge, Mass. (ISBN 026253097X). The SPE feature system comprises fourteen distinctive articulatory or acoustic features, such as voice to represent whether the phoneme is voiced or unvoiced, round to represent the position of the lips, high and low to represent the tongue position during the vowels, and continuant to distinguish continuant sounds such as vowels and fricatives from plosives. For completeness, silence is included as an articulatory feature within the SPE system. To turn these features into a phonetic similarity metric, the phonetic difference score (or “distance”) between any pair of phonemes can be defined as the number of SPE features in which they differ. A full distance matrix constructed in this manner is shown in FIG. 6a.

The maximum phoneme-phoneme distance score in FIG. 6a is 10, which sets a convenient scale for the phonetic matrix. Looking at FIG. 6a it can be seen that many of the phoneme distances make sense intuitively. For example, the distances between the different plosives are between 0 and 5, making them easily confusable as they should be. The distances within each phonetic manner of articulation class also seem to make sense. For example, the distance between T and P, both voiceless plosives articulated at the front of the mouth, is just 2, whereas the distance between T and the voiced velar, back of the mouth, plosive G is 5.

However, not all of the phoneme-phoneme distances in this scheme do make intuitive sense. Accordingly, in a preferred embodiment, the phoneme-phoneme distance between phonemes in different phonetic manner of articulation classes are set at 10, with the distances between phonemes in the same manner of articulation class retained as shown in FIG. 6b.

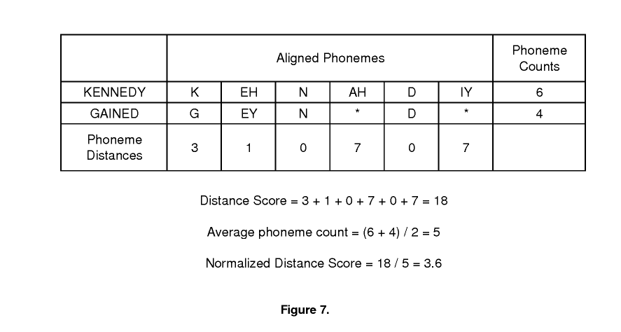

The distance matrix shown in FIG. 6b shows a row and column recording distances to the silence phoneme. These distances are to be interpreted as the insertion/deletion costs in the phonetic edit distance function discussed with reference to FIG. 7 below. In this preferred embodiment, the distance between any phoneme and silence is set uniformly to be 7, but other choices are possible.

FIG. 6b does not include any entries for the affricate phonemes CH and JH. Each of these closely resembles a plosive followed by a homorganic fricative. In the phonetic literature there are disagreements on how to view them, as a single but complex phonemic entity, or as two separate phonemic entities. In this embodiment, the two affricate phonemes are divided into their sub-components and they are then treated as any other sequence of consonants. Hence CH is treated as T followed by SH, and JH as D followed by ZH.

FIG. 7 illustrates a word difference calculation in accordance with the present invention, operating on the words “Kennedy” and “Gained” using the phoneme difference scores of FIG. 6b.

The present invention preferably uses a modified form of the Levenshtein edit distance function in order to determine a phonetic distance between any pair of words. An edit distance function, called Fon, is defined by the following recurrence relation:
Fon(0,0)=0
Fon(i,0)=Fon(i-1,0)+d(sᵢ)
Fon(0,j)=Fon(0,j-1)+d(tⱼ)
Fon(i,j)=Min{Fon(i-1,j)+d(sᵢ),
   Fon(i,j-1)+d(tⱼ),
   Fon(i-1,j-1)+r(sᵢ,tⱼ)}.

In this relation, s₁ . . . sₙ and t₁ . . . tₘ are the strings of phonemes to be compared, r(a, b) is a phonemic replace/substitute cost function and d (a) is a phonemic delete/insert cost function. The values of the replace/substitute costs are defined by the modified SPE phoneme distances shown in FIG. 6b. The values of the delete/insert costs are taken from the same table by defining d(a)=r(a, “SIL”), the distance to the silence phoneme. The final phonetic distance for two phoneme strings is given by Fon(n, m).

When comparing several words or names, it is beneficial to normalise the distance to correct for variations in the word lengths. To do this, the output of Fon(n, m) can be divided by the average number of phonemes in the phonetic strings corresponding to the two words. With this choice of normalisation, phonetic distances below 1.75 to 2.0 seem to represent fairly good phonetic matches. Distances above 2.0 are generally considered poor phonetic matches.

Turning to FIG. 7, the Fon algorithm is illustrated for the words “Kennedy” and “Gained”. It can be seen the accumulated distance score is 18, the average phoneme count is 5 giving a normalised distance of 3.6. This is a poor phonetic match. However, both “Kennedy” and “Gained” are assigned identical phonetic keys in the Soundex™, Metaphone™ and Double Metaphone™ schemes. This illustrates how the present invention is able to better distinguish between poor phonetic matches than the existing systems.

The distance function may be modified to account for different numbers of syllables between words. Syllables may be considered to be the building blocks of words. They have a major influence on the stress, pattern and rhythm of a spoken word, and words that differ in syllable structure generally sound very different, irrespective of their phonetic content.

Deriving the likely syllable structure for a word from its phonetic transcription is a well-studied problem in computational phonetics. In one aspect of the invention, a word syllabification algorithm, based on standard phonetic sonority theory is used. Descriptions of sonority theory and its use in syllable identification can be found in standard reference texts such as “Introducing Phonology” (Hawkins, P. 1984) Hutchinson, London (ISBN 0091550602), or “A Course in Phonetics” (Ladefoged, P. 2006) Thomson-Wadsworth (ISBN 1413006884).

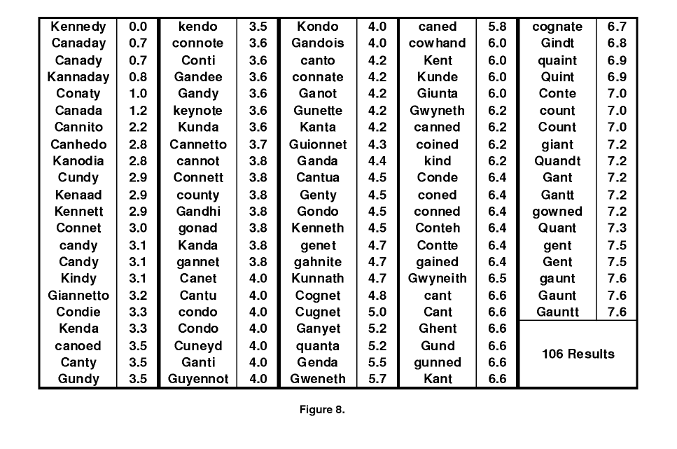

In one embodiment, when calculating the phonetic distance between two words, each difference in syllable is counted as being equivalent to the insertion of a silence. In the example shown in FIG. 6b this corresponds to the addition of 7 to the distance score. Consider, for example, the words “Kennedy” and “Gained”. The unnormalised distance between these two words as illustrated in FIG. 7 is 18. However, the word “Kennedy” has three syllables, whereas “Gained” has just a single syllable. Hence the difference in syllable count is 2, and the syllabically adjusted phonetic distance is 18+7+7 which equals 32. Following normalisation, this distance becomes 32÷5 which equals 6.4, as shown in FIG. 8.

The present invention can incorporate syllabic information into the phonetic key by pre-pending the syllable count onto the standard key described and shown in FIG. 3. Hence the key for “Kennedy” becomes 3 S.V.N.V.S.V. With this modification, the invention can be made to return names only with the same number of syllables as the search name. By contrast, the Soundex™, Metaphone™ and Double Metaphone™ schemes do not discriminate on the basis of a syllable count and therefore each undesirably generate key matches with different numbers of syllables, e.g. “Kennedy” (3 syllables) and “Gained” (1 syllable).

It should be appreciated that the similarity metric of the present invention, exemplified by FIGS. 6 and 7, can be used to score output words derived by any means, not just those retrieved by the system and method described with reference to FIG. 1-5. FIG. 8 shows the output scores for a series of words when compared to the word “Kennedy” using a metric in accordance with the present invention. The set of result words are a set of 106 Double Metaphone™ results for a search on the name “Kennedy”. The best matches in accordance with the distance scores are placed at the top of the list and get progressively worse.

Thus, in one embodiment, the ranking engine comprises software implementing the metric illustrated in FIG. 7, using the distance scores shown in FIG. 6b. The ranking engine takes a phoneme string of an input word from the phoneme converter and provides a similarity score between the input phoneme string and the phoneme strings of the retrieved words from the retrieval engine (or some other source) using the metric described with reference to FIG. 7. The scores are displayed alongside the retrieved words, which are sorted into a rank order.

Other metrics, using different scores to those shown in FIGS. 6a and 6b, and/or using a different distance function may be used. The specific embodiment described has been found to be effective for English names, and can be readily adapted or extended to suit other applications.

1. A method for retrieving words from an electronic database, the method carried out on one or more computer processors, and comprising the steps of:
inputting an input word to the one or more computer processors;
transforming the input word into a string of phonemes, wherein the phonemes are selected from a set of phonemes, using the one or more computer processors;
producing an input key from the string of phonemes using the one or more computer processors, wherein the input key comprises a string of key elements, wherein the key elements are selected from a set of key elements, wherein the phonemes are transformed into corresponding key elements from the set of key elements, wherein each key element in the input key corresponds to one or more phonemes in the string of phonemes and wherein there are fewer key elements in the set of key elements than there are phonemes in the set of phonemes;
retrieving words from the electronic database having a key matching the input key, using the one or more computer processors; and
outputting an output indicative of the retrieved words.

2. The method according to claim 1, further comprising the steps of determining a number of syllables in the input word and including in the input key an indication of the number of syllables.

3. The method according to claim 1, wherein each key element from the set of key elements corresponds to a class of phonemes.

4. The method according to claim 3, wherein each key element from the set of key elements corresponds to a manner of articulation.

5. The method according to claim 1, wherein the records in the electronic database are names.

6. The method according to claim 1, wherein the step of transforming the input word comprises generating two or more different input keys for an input word and retrieving words from the electronic database having a key matching either input key.

7. The method according to claim 1, further comprising the step of ranking retrieved words from the electronic database according to a metric, the metric indicative of the similarity of each retrieved word to the input word.

8. The method according to claim 7, wherein the metric is based on a comparison between the phonemes in a retrieved word and the phonemes in the input word.

9. The method according to claim 8, wherein the metric is based on the result of a distance function performed on phoneme strings.

10. The method according to claim 9, wherein the distance function is an edit-distance function.

11. The method according to claim 1, wherein the step of transforming the input word comprises checking an electronic dictionary of words and their corresponding phoneme strings, and if a word matching the input word is in the dictionary selecting the matching phoneme string, otherwise executing a phoneme string generating algorithm on the input word.

12. A system for retrieving words from an electronic database, comprising:
a phoneme converter for converting an input word into a string of phonemes, the phonemes selected from a set of phonemes stored in a memory;
a key generator for converting the string of phonemes into an input key, wherein the input key comprises a string of key elements, wherein the key elements are selected from a set of key elements, wherein the phonemes are transformed into corresponding key elements from the set of key elements, wherein each key element in the input key corresponds to one or more phonemes in the string of phonemes and wherein there are fewer key elements in the set of key elements than there are phonemes in the set of phonemes;
a retrieval engine for retrieving words from the database, wherein each word in the database has a corresponding key, and wherein the retrieval engine retrieves words from the database having a key matching the input key; and
an output coupled to the retrieval engine for outputting the retrieved words.

13. The system according to claim 12, wherein the key generator is configured to include an indication of a number of syllables in the input word in the input key.

14. The system according to claim 12, wherein each key element from the set of key elements corresponds to a class of phonemes.

15. The system according to claim 12, wherein the phoneme converter is configured to generate two or more different input keys for an input word and the retrieval engine is configured to retrieve words from the electronic database having a key matching either input key.

16. The system according to claim 12, further comprising a ranking engine, the ranking engine ranking retrieved words from the electronic database according to a metric, the metric indicative of the similarity of each retrieved word to the input word.

17. The system according to claim 16, wherein the metric is based on a comparison between the phonemes in a retrieved word and the phonemes in the input word.

18. The system according to claim 17, wherein the metric is based on the result of an edit-distance function performed on phoneme strings.

19. The system according to claim 12, wherein the phoneme converter is configured to check an electronic dictionary of words and matching phoneme strings, and if a word matching the input word is in the dictionary to select the matching phoneme string, otherwise to generate a phoneme string based on the input word.

20. A computer readable storage medium containing instructions that are executable on one or more computer processors to retrieve words from an electronic database, the instructions performing steps comprising:
inputting an input word to the one or more computer processors;
transforming the input word into a string of phonemes, wherein the phonemes are selected from a set of phonemes, using the one or more computer processors;
producing an input key from the string of phonemes using the one or more computer processors, wherein the input key comprises a string of key elements, wherein the key elements are selected from a set of key elements, wherein the phonemes are transformed into corresponding key elements from the set of key elements, wherein each key element in the input key corresponds to one or more phonemes in the string of phonemes and wherein there are fewer key elements in the set of key elements than there are phonemes in the set of phonemes;
retrieving words from the electronic database having a key matching the input key, using the one or more computer processors; and
outputting an indication of the retrieved words.

21. A method of indexing a database of words, the method carried out on one or more computer processors, and comprising the steps of:
transforming each word from the database into a string of phonemes, wherein the phonemes are selected from a set of phonemes, using the one or more computer processors;
producing a key for each string of phonemes using the one or more computer processors, wherein each key comprises a string of key elements, wherein the key elements are selected from a set of key elements, wherein each phoneme in each string of phonemes is transformed into a corresponding key element from the set of key elements and wherein there are fewer key elements in the set of key elements than there are phonemes in the set of phonemes; and
storing as an index a key corresponding to each word in the database together with an indication of the word to which it corresponds.

22. A method of generating keys corresponding to input words, the method carried out on one or more computer processors, and comprising the steps of:
inputting an input word to the one or more computer processors;
transforming the input word into a string of phonemes, wherein the phonemes are selected from a set of phonemes, using the one or more computer processors;
producing a key from the string of phonemes using the one or more computer processors, wherein the key comprises a string of key elements, wherein the key elements are selected from a set of key elements, wherein each phoneme is transformed into a corresponding key element from the set of key elements and wherein there are fewer key elements in the set of key elements than there are phonemes in the set of phonemes.

23. A method of ranking a set of output words retrieved from an electronic database based on their similarity to an input word, performed on one or more computer processors, comprising:
transforming the input word into a first string of phonemes, the phonemes selected from a set of phonemes, using one or more computer processors;
comparing the first string of phonemes with a second string of phonemes corresponding to each output word, the phonemes in each second string of phonemes being selected from the set of phonemes, to produce a quantitative measure of the similarity between the input word and each output word, using one or more computer processors, the quantitative measure being based on difference scores between phonemes in the first phoneme string and in each second phoneme string, a predetermined difference score being assigned to each possible pair of phonemes taken from the set of phonemes; and
displaying the output words either in a rank order based on the quantitative measure for each output word or together with an indication of the quantitative measure for each output word.

24. The method according to claim 23, wherein the step of comparing the first string of phonemes with each second string of phonemes comprises performing a distance function on the first and second string of phonemes to produce the quantitative measure.

25. The method according to claim 24, wherein the distance function is an edit-distance function.

26. The method according to claim 23, wherein the step of comparing the first string of phonemes with each second string of phonemes further includes comparing a number of syllables in the input word with a number of syllables in the output word and including a syllable difference score in the quantitative measure.

27. The method according to claim 23, wherein each phoneme in the set of phonemes is assigned to a class of phonemes and wherein the step of assigning a difference score to each possible pair of phonemes comprises assigning a higher difference score to pairs of phonemes in different phoneme classes than to phonemes in the same phoneme class.

28. The method according to claim 23, further comprising filtering the output words on the basis of the quantitative measure for each output word.

29. The method according to claim 23, wherein the output words are names.

30. The method according to claim 23, further comprising retrieving the set of output words from the electronic database by the steps of:
inputting an input word to the one or more computer processors;
transforming the input word into a string of phonemes, wherein the phonemes are selected from a set of phonemes, using the one or more computer processors;
producing an input key from the string of phonemes using the one or more computer processors, wherein the input key comprises a string of key elements, wherein the key elements are selected from a set of key elements, wherein the phonemes are transformed into corresponding key elements from the set of key elements, wherein each key element in the input key corresponds to one or more phonemes in the string of phonemes and wherein there are fewer key elements in the set of key elements than there are phonemes in the set of phonemes;
retrieving words from the electronic database having a key matching the input key, using the one or more computer processors; and
outputting an output indicative of the retrieved words.

31. A system for ranking a set of output words retrieved from an electronic database based on their similarity to an input word, the system comprising:
a phoneme converter for transforming the input word into a first string of phonemes, the phonemes selected from a set of phonemes;
a memory, storing a lookup table assigning a difference score to each possible pair of phonemes taken from the set of phonemes;
a comparator for comparing the first string of phonemes with a second string of phonemes for each output word, the phonemes in each second string of phonemes being selected from the set of phonemes, to produce a quantitative measure of the similarity between the input word and each output word, the quantitative measure being based on difference scores between the phonemes in the first phoneme string and in each second phoneme string; and
a display, connected to the comparing means, for displaying the output words either in a rank order based on the quantitative measure for each output word or together with an indication of the quantitative measure for each output word.

32. The system according to claim 31, wherein the comparator is configured to perform a distance function on the first and second string of phonemes to produce the quantitative measure.

33. The system according to claim 31, wherein the comparator is configured to compare a number of syllables in the input word with a number of syllables in the output word and include a syllable difference score in the quantitative measure.

34. The system according to claim 31, wherein each phoneme in the set of phonemes is assigned to a class of phonemes and wherein the look-up table assigns a higher difference score to pairs of phonemes in different phoneme classes than to phonemes in the same phoneme class.

35. The system according to claim 31, further comprising a filter for filtering the output words on the basis of the quantitative measure for each output word.

36. The system according to claim 31, further comprising:
a phoneme converter for converting an input word into a string of phonemes, the phonemes selected from a set of phonemes stored in a memory;
a key generator for converting the string of phonemes into an input key, wherein the input key comprises a string of key elements, wherein the key elements are selected from a set of key elements, wherein the phonemes are transformed into corresponding key elements from the set of key elements, wherein each key element in the input key corresponds to one or more phonemes in the string of phonemes and wherein there are fewer key elements in the set of key elements than there are phonemes in the set of phonemes;
a retrieval engine for retrieving words from the database, wherein each word in the database has a corresponding key, and wherein the retrieval engine retrieves words from the database having a key matching the input key; and
an output coupled to the retrieval engine for outputting the retrieved words.

37. A computer readable storage medium containing instructions that are executable on one or more computer processors to rank a set of output words retrieved from an electronic database based on their similarity to an input word, the instructions performing steps comprising:
transforming the input word into a first string of phonemes, the phonemes selected from a set of phonemes, using one or more computer processors;
comparing the first string of phonemes with a second string of phonemes corresponding to each output word, the phonemes in each second string of phonemes being selected from the set of phonemes, to produce a quantitative measure of the similarity between the input word and each output word, using one or more computer processors, the quantitative measure being based on difference scores between phonemes in the first phoneme string and in each second phoneme string, a predetermined difference score being assigned to each possible pair of phonemes taken from the set of phonemes; and
displaying the output words either in a rank order based on the quantitative measure for each output word or together with an indication of the quantitative measure for each output word.

38. The computer readable storage medium containing instructions that are executable on one or more computer processors according to claim 37, the instructions performing steps further comprising:
inputting an input word to the one or more computer processors;
transforming the input word into a string of phonemes, wherein the phonemes are selected from a set of phonemes, using the one or more computer processors;
producing an input key from the string of phonemes using the one or more computer processors, wherein the input key comprises a string of key elements, wherein the key elements are selected from a set of key elements, wherein the phonemes are transformed into corresponding key elements from the set of key elements, wherein each key element in the input key corresponds to one or more phonemes in the string of phonemes and wherein there are fewer key elements in the set of key elements than there are phonemes in the set of phonemes;
retrieving words from the electronic database having a key matching the input key, using the one or more computer processors; and
outputting an indication of the retrieved words.
